(19) United States
(12) Patent Application Publication
(10) Pub. No.: US 2011/0258127 A1
(43) Pub. Date: Oct. 20, 2011

(54) METHOD, COMPUTER PROGRAM PRODUCT, DEVICE, AND SYSTEM FOR CREATING AN ELECTRONIC APPRAISAL REPORT AND AUDITING SYSTEM

(75) Inventors: Benjamin Graboske, Santa Ana, CA (US); Susan Allen, Santa Ana, CA (US)

(73) Assignee: Corelogic Information Solutions, Inc., Santa Ana, CA (US)

(21) Appl. No.: 13/080,231

(22) Filed: Apr. 5, 2011

Related U.S. Application Data
(60) Provisional application No. 61/321,301, filed on Apr. 6, 2010.

(51) Int. Cl. G06Q 50/00

(52) U.S. Cl. 705/306

(57) ABSTRACT

The present disclosure discloses a method, computer program product, device, and system for creating an electronic appraisal form with auditing capabilities. The device includes a display, a data input module, a location detection module which detects a geographic position, a communications interface which communicates with a real estate database, and retrieves real estate data for a property located at the geographic position detected by the location detection module. The device further includes a processor which creates an electronic appraisal template including a plurality of data fields, the plurality of data fields being automatically populated based on the received real estate data for the property located at the geographic position, and an audit tracking module which maintains a record of data initially presented for inclusion in an appraisal report, but ultimately excluded from the appraisal report.

### CROSS-REFERENCE TO RELATED APPLICATIONS

The present application claims the benefit under 35 U.S.C. §119 from U.S. Provisional Application No. 61/321,301, filed Apr. 6, 2010, which is herein incorporated by reference in its entirety.

### BACKGROUND

1. Technological Field

The present disclosure relates to the field of real estate, and more specifically to the field of appraisal reports.

2. Description of the Related Art

Thousands of houses are appraised each year throughout the United States. A manual appraisal is often required by lenders or investment institutions to assist in their assessment of financing a real estate transaction. Generally, a certified appraiser is responsible for traveling to the home to be appraised and to provide a professional valuation of that home. The appraiser is responsible for compiling various types of information which would factor in the appraiser's valuation of the home and in creating his/her appraisal report. For example, the appraiser may consider factors such as, but not limited to, the number of bedrooms, location, living space, number of bathrooms, comparables, condition of the interior, number of garage spaces, the presence of a swimming pool, or the like. The appraiser often needs to access various databases to get each data element that is needed to assist with his/her valuation of the home.

Appraisals are most commonly performed as support for a real estate lending transaction. Appraisers are either directly engaged by a lending institution, or, more commonly, the bank places appraisal orders through an Appraisal Management Company (AMC) who then works with an appraiser to complete the report. Once an appraisal is completed, both the AMC and the bank must evaluate the appraisal to ensure it meets the institution's quality guidelines. The mortgage industry also includes Government Sponsored Entities (GSE) such as Fannie Ma, securitization parties such as ratings agencies, investors in Mortgage-Backed Securities (MBS), Mortgage Insurers (MI), and others. Disputes over appraisal accuracy may arise years after the appraisal was originally delivered. Thus, there are many parties who may wish to examine the accuracy of an appraisal, both at the time the appraisal was created and several years later.

There are many types of appraisal forms which are used in creating an appraisal report. One of the most common forms used in real estate appraisal, the Uniform Residential Appraisal Report (URAR), was created to allow for standard reporting and analysis of single family dwellings or single family dwellings with an “accessory unit.” URAR may also be suitable for a building in a Planned Unit Development (PUD), but is not meant to be used for appraisals of manufactured homes or condominiums. The most current form of the URAR is the Fannie Mae Form 1004 (1004 form). U.S. Provisional Application No. 61/321,301, which is incorporated herein by reference in its entirety, shows a sample 1004 form (i.e., FIGS. 1-3 of the aforementioned application) used by an appraiser and the various fields included in the 1004 form.

The appraiser is responsible for compiling all of the information that is relevant in providing a proper valuation and completing the 1004 form, or any other relevant URAR appraisal forms. One portion of an appraisal report requires the appraiser to provide a list of comparable houses (“comps”) and their sale values. For example, an appraiser uses houses sold within a desired vicinity and having the same characteristics (e.g., number of rooms, square footage, year built, or the like) in determining the most accurate valuation. Another factor which the appraiser generally considers in choosing a comp is how recent the sale was on the comp. Therefore, if an appraiser wishes to have a higher valuation for a home, he/she could pick and choose homes most favorable in supporting his/her valuation to be included in the appraisal report, while excluding others. Currently, there is no way of knowing which properties were excluded from the valuation process. Thus, the ability to manipulate the value of the house being appraised allows for fraud. On the other hand, an appraiser could also make human errors by entering incorrect and/or inaccurate information when deciding on which comps to select.

Appraisers generally have to gather the information manually and then attempt to compile the data and enter the information into the report. This process allows for many types of human error. Furthermore, many times the AMCs, lending institutions, GSEs, MBS investors, MI companies, and other interested parties reviewing the appraiser's appraisal report have a difficult time understanding what data was available to the appraiser at the time the appraiser delivered the report, how the appraiser picked the various data to be included in the report, why the appraiser's data may differ from county records, and how the appraiser compared property sales and listings to the subject property being evaluated. As recognized by the present inventors, it is also beneficial for appraisal reviewers to understand how the process of conducting the subject property appraisal compares to this appraiser's (and other appraiser's) reports on other local properties. For example, if 40% of the subject property appraisal data matched county records, yet typical local appraisals match county records 95% of the time, a reviewer may wish to conduct a deeper review.

### SUMMARY

The present disclosure discloses a method, computer program product, device, and system for creating an electronic appraisal form with auditing capabilities. The device includes a display, a data input module, a location detection module which detects a geographic position, a communications interface which communicates with a real estate database, and retrieves real estate data for a property located at the geographic position detected by the location detection module. The device further includes a processor which creates an electronic appraisal template including a plurality of data fields, the plurality of data fields being automatically populated based on the received real estate data for the property located at the geographic position, and an audit tracking module which maintains a record of data initially presented for inclusion in an appraisal report, but ultimately excluded from the appraisal report.

Furthermore, the system provides feedback to the appraiser during an appraisal process, based on how the appraiser's process may deviate from other appraiser's performance on similar properties or similar areas. The appraiser may also receive feedback relative to lender guidelines. For example, a lender may want all three comparable sales to be within a predetermined range of the subject property, such as one mile, otherwise a comment is required. This feedback from an auditing process, is not only based on the results as reported by other appraisal reports, but also based on the information developed through the auditing data. Accordingly, the present system identifies what data is chosen by the appraiser to be excluded from the final appraisal. The present inventors recognize that valuable information regarding the potential source errors and appraisal report arise, or perhaps bias results stream, from data that is selected by an appraiser to be excluded from the appraisal report. The present system offers queries to the appraiser during the appraisal process, based on audited data previously collected, so as to “second-guess” the appraiser when the appraiser opts to exclude certain information that may be available to the appraiser for including in the appraisal report.

As should be apparent, a number of advantageous features and benefits are available by way of the disclosed embodiments and extensions thereof. It is to be understood that any embodiment can be constructed to include one or more features or benefits of embodiments disclosed herein, but not others. Accordingly, it is to be understood that the embodiments discussed herein are provided as examples and are not to be construed as limiting, particularly since embodiments can be formed to practice the invention that do not include each of the features of the disclosed examples.

### BRIEF DESCRIPTION OF THE DRAWINGS

The disclosure will be better understood from reading the description which follows and from examining the accompanying figures. These are provided solely as non-limiting examples of embodiments. In the drawings:

FIG. 1 is a network overview of an embodiment of the system for creating an appraisal report;

FIG. 2 is a flow chart of the operation of the system show in FIG. 1;

FIGS. 3A and 3B are exemplary screen shots showing an auditing feature;

FIG. 4 is an exemplary audit trail report;

FIG. 5 shows exemplary analytical data; and

FIG. 6 illustrates a computer system upon which an embodiment of the present disclosure may be implemented.

### DETAILED DESCRIPTION

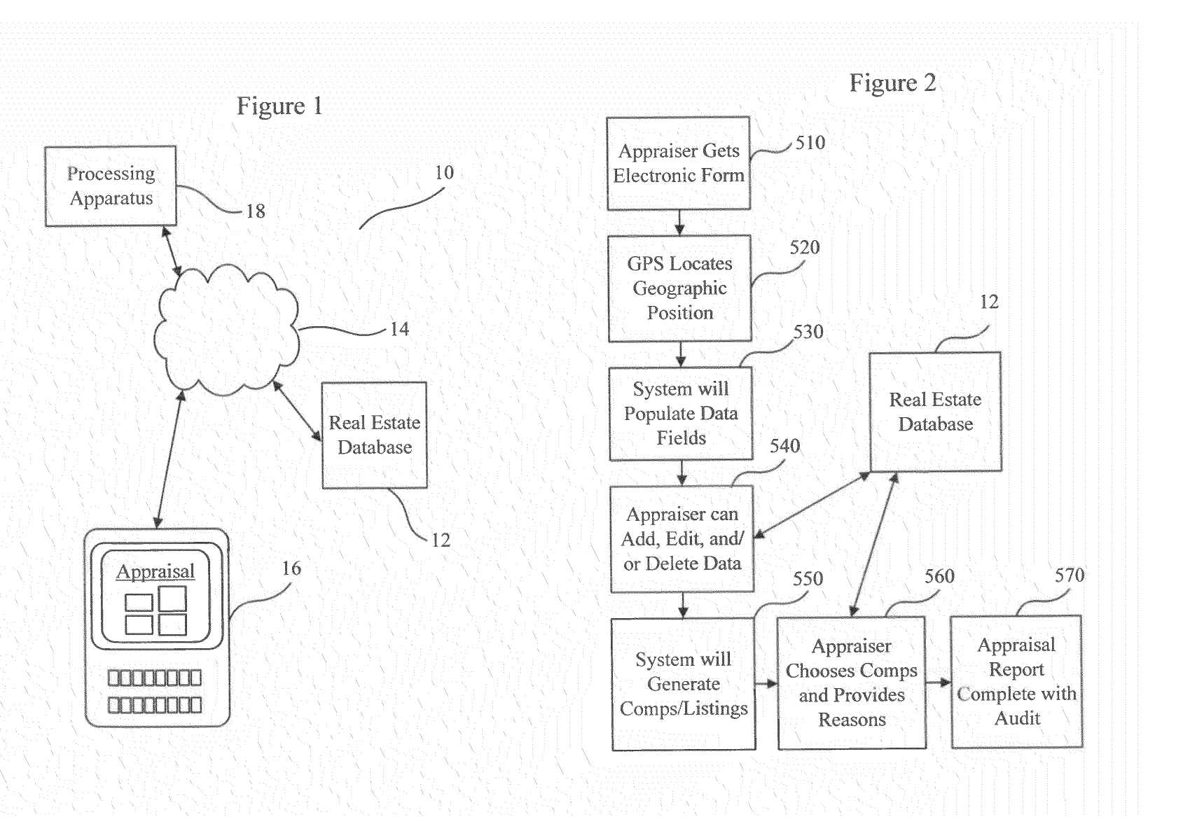

FIG. 1 is a block diagram of a system 10 for creating an appraisal report which includes a real estate database 12 that is connected to a communication network 14. The user may be an appraiser, appraisal company, lender, investor, real estate broker, a consumer, or the like. A computing device 16 is connected to the network 14 and accesses the database 12. Although only one computing device 16 is shown in FIG. 1, the database 12 can be accessed simultaneously by a plurality of computing devices. A wireless access database, for example, can also connect to the network 14 in order to access the database 12. In addition, a processing apparatus 18 may also be connected to the network 14 and may access, and be accessed by, the real estate database 12 and/or the computing device 16.

The real estate database 12 may be one database or may include a plurality of databases. In an embodiment, the real estate database includes a database which includes data gathered from various real estate databases including, but not limited to, Multiple Listing Service (MLS), Tax Roll Database, Real Estate Owned (REO) information, Automated Valuation Model (AVM) database, or any other related real property databases. In an embodiment, the system 10 may have access to CORELOGIC's real property database, MARKETLINX'S® MLS database, EAPPRAISEIT'S™ appraisal database, and CORELOGIC Real Estate Solutions' tax roll and flood and hazardous database. Another database, for example, may include photographs of properties, such as photographs of the interior and exterior of a home. Another database, for example, may include data contributed for this purpose by various CORELOGIC constituents such as lenders, appraisers, investors, etc. The database 12 may further be connected to two or more databases (not shown) which may include all of the data relevant in completing an appraisal form or template.

In an embodiment, the system 10 correlates data between the various databases and the fields in an Uniform Residential Appraisal Report (URAR) form. Based on this correlation, the system 10 is able to populate the appraisal form or template by mapping information received from a database to the respective fields in the form or template. Different fields included in database entries in the various databases are provided with a field code (e.g., address, latitudinal/longitudinal coordinates, number of bedrooms, or the like) for each of the respective fields. Likewise, the URAR is provided with a similar field code (e.g., address, latitudinal/longitudinal coordinates, number of bedrooms, or the like). The system then extracts the database entries for the respective field having a field code and populates an electronic version of the URAR (i.e., an appraisal form or template) in a field having a common field code (e.g., address, latitudinal/longitudinal coordinates, number of bedrooms, or the like). By normalizing the database entries from the various databases in a common format with the various fields of the URAR, it is possible to auto-populate the URAR with the database entries. Optionally, the system does not auto-populate the URAR, but includes manual entries in one version of the URAR as input from the appraiser. The system also includes a second version of the entries for the URAR, but the entries in the second version are populated with the information provided from the respective database(s). When a third version has been found, or a discrepancy exists between the database entries and URAR version 1 and URAR version 2, it is the discrepancy that triggers the reporting function to the appraiser, as well as triggers the internal audit operation indicating that the discrepancy has been identified and observing how the appraiser reacts to those differences once identified.

In another embodiment, an appraisal database, which includes all of the data for all the appraisal forms that have been completed by an appraiser or person valuing a home (e.g., a Broker Price Opinion (BPO) agent), may be included within the real estate database 12. The appraisal database may allow a user access to all previous appraisals that have been completed and/or saved into the system for various homes, as well as various historical data. Such a feature allows a user to retrieve historical data and assess the appraiser's performance by creating an auditing trail. The processing apparatus 18, for example, may access the appraisal database to collect certain information or data and generate analytics. Analytics are described in more detail below.

The auditing trail not only keeps track of different discrepancies that are identified between version 1 and version 2 of the URAR, but also identifies what information is excluded by the appraiser in preparing the appraisal report. Such data may include comparables (other properties with similar features) that were excluded by the appraiser, despite the comparables having features that may indicate similarities of the comparables to the subject house. Example considerations include proximity of the comparable to the subject property, price, number of bedrooms, acreage, or the like.

An embodiment of the present disclosure includes at least a computing device and a system that has a Global Positioning System (GPS) feature built in. The GPS feature allows for the automatic population of a form based on the location of the device at a particular location. The device may then use that location to query a public records database or proprietary database that has fields associated with that particular property and a form to be filled out by the appraiser so as to help autopopulate the form. In the database, particular fields are tagged and used as a mechanism for correlating particular fields to blank entries in the appraisal form. For example, one field may be “rooms.” The database includes a particular tag that associates that field with a particular entry point on the appraisal form. That form may be either a proprietary form or a form used in the industry with a predetermined format. Each form will have associated tags that allow for correlation between the entries in the fields of the database with the entry points on the form. In the example, the tag associated with the field describing rooms is used to populate the appraisal form having fields (to be filled in) with entries where the particular fields are identified with corresponding tags.

The computing device 16 (i.e., a portable electronic appraisal device) may include a desktop computer, laptop computer, Personal Digital Assistant (PDA), cellular phone, or any type of mobile device capable of receiving, transmitting, and/or displaying data. In one embodiment, the computing device 16 may be a wireless device having a user interface which allows the user to enter and retrieve information. For example, the computing device 16 may have a data input module such as a keyboard or a touch screen which allows the user to enter in both text and upload data files (e.g., images, documents, charts, or the like). Furthermore, the computing device 16 may include photographic equipment or image capturing device (e.g., a camera) capable of capturing images and incorporating the images into the electronic appraisal form or template. In addition, the computing device 16 may include a location detection module such as an interface or transmitter which is used in determining the geographic position of the device 16. For example, a Global Positioning System (GPS) able to calculate the position of the computing device 16 may be used. Alternatively, Code Division Multiple Access (CDMA) cellular positioning technology may also be used. Based on the position of the computing device 16, the computing device 16 is able to obtain all of the relevant real estate data from the real estate database 12. Accordingly, in one embodiment, a property may be identified by the location or geographic position, without requiring a specific address. In another embodiment, the property may also be identified by its address alone. In yet another embodiment of the present disclosure, the property may be identified both by location and its specific address.

For example, if the GPS detects that the computing device 16 is at 123 Main Street, Irvine, Calif. 92618, then the computing device 16 is able to pull all of the relevant real estate property information from the real estate database 12 to populate the various fields in an electronic appraisal form relating to the property located at the aforementioned address.

In the performance of the detection process, the GPS may identify particular latitudinal/longitudinal coordinates for the subject property, while the database may include different coordinates. However, the present system recognizes that the property boundary of an individual subject property or a comparable property will have a number of latitudinal/longitudinal coordinates that fall within the borders of the property. Accordingly, the system 10 will also check for particular latitudinal/longitudinal coordinates, as detected by the GPS equipment used by the appraiser, in comparing the same to any latitudinal/longitudinal coordinates that fall within the property boundary for the subject property or a comparable. With this approach, the subject property and the corresponding entry in the database are more reliably identified.

In an embodiment, the computing device 16 may prompt the user to confirm that the address of the home it has detected is correct. Furthermore, the computing device 16 may also provide a list of other possible locations, such as 124 Main Street, 125 Main Street, or the like, to the user. The user may then select the location, thereby ensuring that the desired data is pulled up, and the electronic appraisal form is populated, with the proper information. In another embodiment, the data in the real estate database 12 may be pre-coded to match certain fields in electronic appraisal forms.

The processing apparatus 18 may be used to track an audit and generate appraisal reports. For example, a computing device 16 may send the necessary information to the processing apparatus 18, and the apparatus 18 may then use the information to create an appraisal report. The processing apparatus 18 may also gather information from any of the aforementioned databases, process the information, and then use it to create various analytics. Analytics are described in more detail below. The computing device 16 may also have the capability to track an audit and to generate appraisal reports.

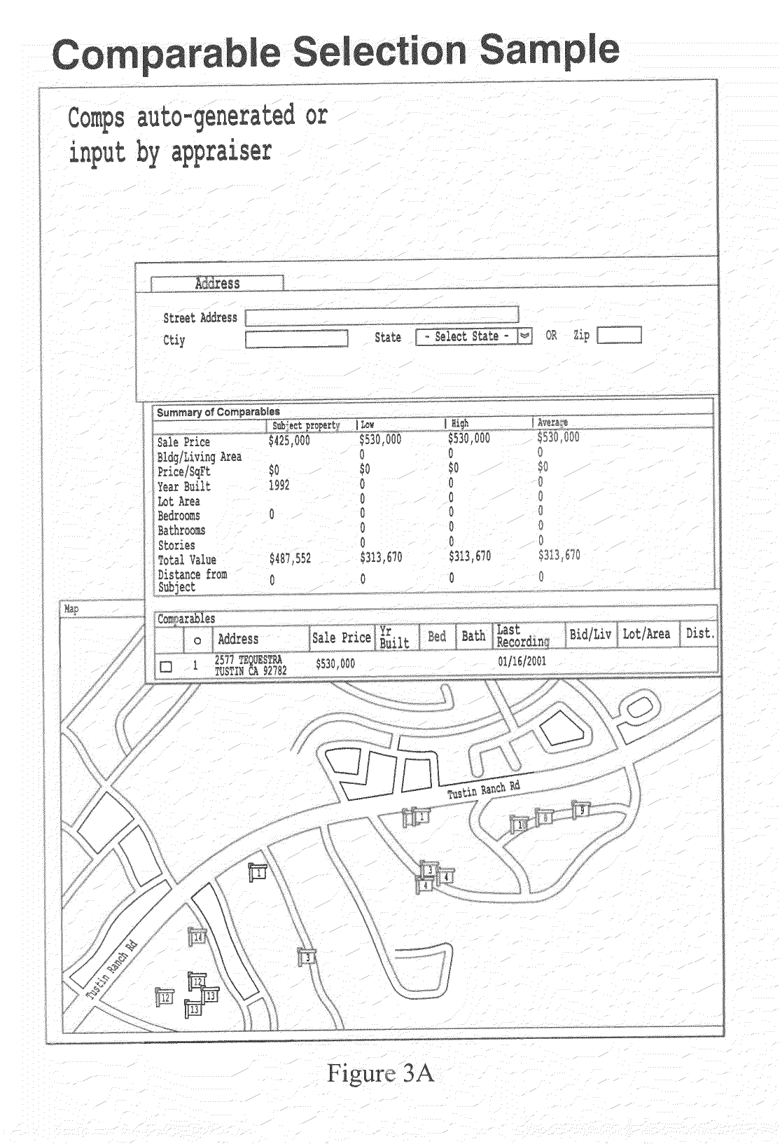

FIG. 2 is a flow chart of the operation of the system shown in FIG. 1. At step 510, an appraiser gets an electronic appraisal form or template on the computing device 16. Such form may be the Fannie Mae 1004 form, or an appraisal form that is configured by the user and meets Uniform Standards of Professional Appraisal Practice (USPAP) requirements. In step 520, the GPS locates the geographic position of the computing device 16. However, alternatively, the user may enter data into the electronic form or edit data of the electronic form by using any type of input function, such as a keyboard, on the computing device 16. Thus, the appraiser may manually key in the subject property, may allow the GPS to automatically detect the property being appraised, or a combination of both.

At Step 530, the appraisal system 10 automatically populates the data fields on the electronic appraisal form with the corresponding data in the real estate database 12. This data may come from a plurality of databases as noted above (e.g., MLS, Tax Roll, REO's, Estimate Values, Recorder Images, URAR forms tools database, or the like), or one database containing all of the data. At step 540, the appraiser may update the data that has been populated, or fill in any fields which are blank. The appraiser may also add or edit any of the data of the form.

The system 10 keeps track of all of the changes, additions, or edits the appraiser makes and records the changes and any other relevant information (e.g., date and time of change/modification, the initials/name of the appraiser making the changes, or the like). In an embodiment, once the appraiser has updated the data, the system may retrieve relevant Comparables and Listings, as shown in step 550.

The present inventors recognize identifying not only the available data kept in an appraisal process, but also the information that has been selected to be removed from the appraisal consideration. The present system, when recognizing that the appraisal process excludes data (e.g., comparable within one mile of the property having common acreage and same number of bedrooms) from an appraisal report, prompts the appraiser with this information so the appraiser can reconsider whether he/she would like to exclude the comparable presented by the system. Part of the auditing trail includes the saving and recording of the fact that the appraiser was presented with the opportunity to include another comparable, and he/she purposely selected to exclude that comparable from the appraisal report. This system may also request that the appraiser note the reason for excluding the comparable so that the end user (i.e., a reviewer) is aware that the comparable was considered and the reason for the rejection or exclusion. One embodiment of this feature may be the ability for the appraiser to select a reason for non-use from among a list of predetermined options, including such options as “inaccurate public record data” or “condition of property substantially different from subject property.” This information may subsequently be made available in transaction or summary format to lenders who must ensure the quality of appraisals. As such, the auditing information is helpful to subsequently determine whether the appraisal process performed on the subject property is consistent with the standard appraisal practices within a region or a certain class of properties. Moreover, this collection of information helps identify whether an intentional bias was inserted in the appraisal process which may ultimately affect the outcome of the appraisal report.

Another category of appraisal reports may be useful to lenders, appraisal management companies, or others interested in reviewing the quality of individual or groups of appraisals. For example, an individual appraiser's action (including, but not limited to, comparable selection reasons, adjustments, market trends, data corrections, etc.) should primarily align with the prevalent practices in the particular neighborhood. This system may detect exceptional behavior by comparing an individual appraiser's choices with the choices of his or her peers. This system also enables comparisons of groups of appraisers, whether grouped by geography, employer, types of assignments, or the like.

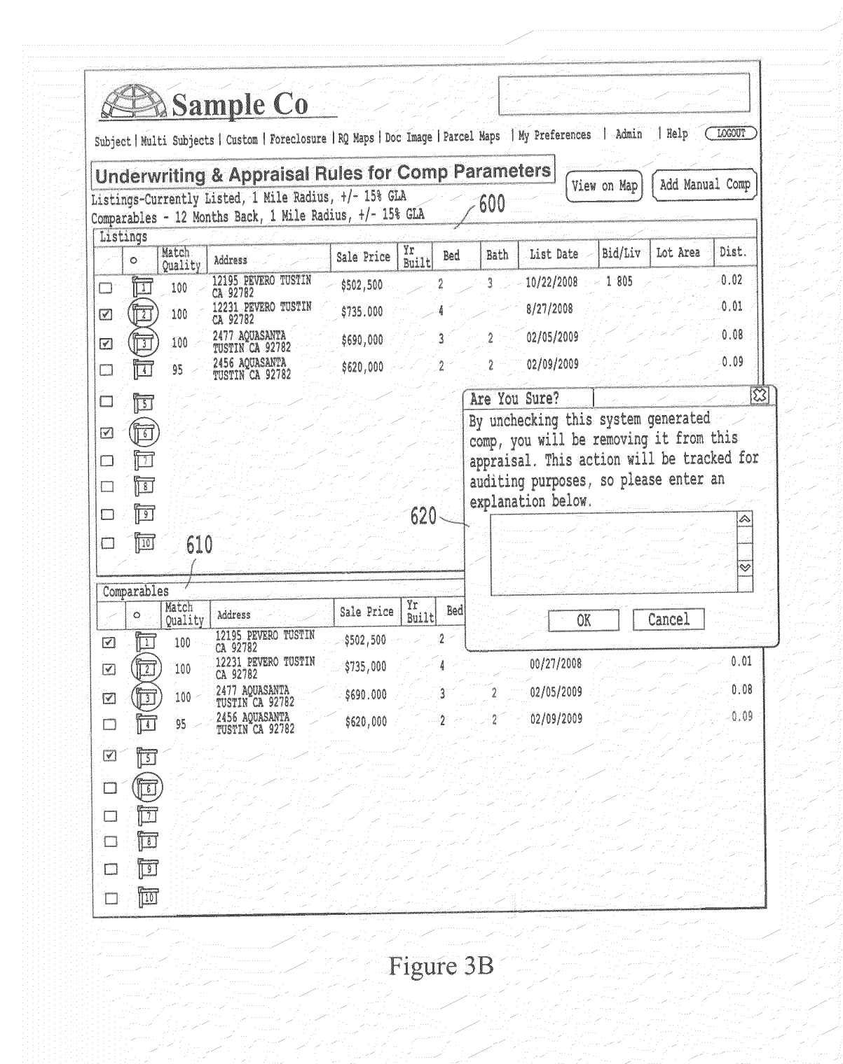

FIGS. 3A and 3B are examples of screen shots of the electronic appraisal system 10, which include a number of similar Listings 600 and Comparables 610. Listings 600 is a list of houses which are currently on the market for sale that have similar characteristics as the house, or property, which is being appraised. This information may be retrieved from an MLS database, for example. Comparables 610 lists houses which have sold within a recent time period and have similar characteristics as the house which is being appraised. Comparables 610 may be either manual appraisals or valuations derived from an Automated Valuation Model (AVM). The system 10 is able to retrieve all of the relevant Listings 600 and Comparables 610 which may be considered by the appraiser. However, in step 550, the appraiser may narrow down the list to the Listings and Comparables that he/she believes to be the most relevant.

As shown in FIGS. 3A and 3B, the system 10 prompts the user with a “Are you sure” message 620 when the appraiser indicates he/she wants to delete, or exclude, a property from the provided lists. The appraiser is prompted to provide an explanation of the reason he/she has decided to remove the specific Comparables 610 and/or Listings 600 he/she believes is not relevant. This explanation is then stored, thereby creating an audit trail report. The audit trail allows a future user to follow the appraiser's logic in arriving at his/her valuation. In addition, the audit trail may also be used to check the appraiser's work or to provide certain statistics about the appraiser.

The additions, changes, or deletions the appraiser makes in either steps 540 and/or 560, may be stored in the real estate database 12, a storage unit of the processing apparatus 18, or in any other database or storage device. At step 570, the appraisal report is completed, including the information of any additions, changes, or deletions made by the appraiser.

Furthermore, the system 10 may provide the appraiser with real-time feedback during any of the steps of FIG. 2. This real-time feedback may consist of statistical and non-parametric information from past appraisals performed using the system 10 of the present disclosure. Real-time feedback may be prompted based on an appraiser's actions. For example, if the appraiser chooses to add a comp property that is two miles away from the subject property, a message may be displayed noting that other appraisers have found comparables within one mile of the subject property. The message may further display a question such as: “Are you sure you want to include the selected property?” If the appraiser chooses to include the property, he/she may be prompted to comment as to why the property is included in the appraisal report. Thus, a person reviewing the appraiser's work in the future may have some understanding of the logic behind the appraiser's choices to include or exclude properties.

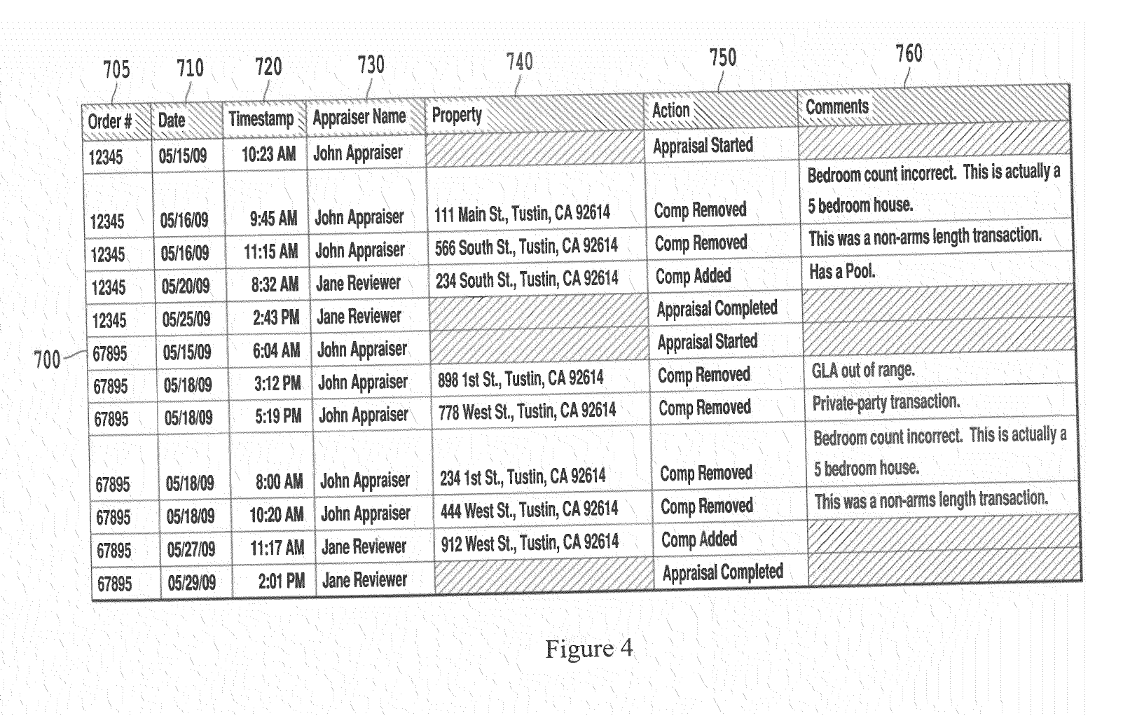

As shown in FIG. 4, the system 10 provides an audit trail report 700 that shows the history of the information being added, deleted, and modified. Such information may include, but is not limited to, the data entered by the appraiser, whether the data is deleted, added, or modified, the name of the appraiser, the last edit, including the time and date of the edit, the data entered by the database, or any images uploaded by the appraiser with relevant information. Specifically, in FIG. 4, the audit trail report 700 shows an order number 705, a date 710, a timestamp 720, the appraiser's name 730, the properties 740, the action 750 taken by the appraiser (i.e., comp removed, comp added, appraisal completed, or the like), and a comments section 760.

Note that with the report 700 of the present disclosure, both the properties that were included in the appraisal process (i.e., properties designated as “comp added” in the action 750 column) and the properties that were excluded from the process (i.e., properties designated as “comp removed” in the action 750 column) are included. Whenever a certain action is taken (i.e., “comp removed” in the action 750 column), the appraiser is prompted to enter comments 760 explaining his/her logic in removing, or including, a certain property. For example, the appraiser noted that the property at 111 Main St., Tustin, Calif. 92614 was removed because the bedroom count was incorrect, as indicated in the comments 760 column. Such information may be important when another person or party is reviewing the appraiser's work, either right after the appraisal is completed or years later. The information enables someone who was not a part of the initial appraisal process to be able to understand the logic behind the appraiser's choices in including or excluding properties. In addition, this information serves as a check against a fraudulent appraisal report.

With regard to the auditing trail, appraisers enter data onto the form in the usual circumstance. However, it is possible that an appraiser does not choose a field to populate and instead is presented with different messages that may be selected by the appraiser. Depending on the pattern of selection or non-selection by a particular appraiser, particular analytics may be developed based on the entry habits of the appraiser and perhaps other appraisers in the area. For example, in a particular geographic region that has land unsuitable for basements, the system prompts the appraiser to select that no basement is present. If the appraiser routinely selects this particular message, the system self-learns and begins to auto-populate entries on the form based on the past patterns of the appraiser. This is because the appraiser works in particular geographic regions that may have common features associated with the properties being reviewed, such as an area that is unsuitable for basements. The system also benefits from the use of “clustering” where groups of properties in a common region are within a pool of properties handled by a particular appraiser and have common features. Those common features may then give rise to analytics that are used to detect potentially fraudulent entries or inadvertent errors entered into the appraisal process.

As an example, suppose properties in a particular area commonly have infinity edge swimming pools. The swimming pools of this type typically having a value of $35,000 are aggregated as part of a “cluster.” Moreover, as more data is collected regarding the cluster of properties having infinity edge swimming pools, it will give rise to statistical distributions regarding appraised prices for that particular feature (in this case an infinity edge swimming pool). Then, when the appraiser appraising a new property having an infinity edge swimming pool enters a value such as $75,000, the system uses analytics, such as a statistical deviation (standard deviation, percentage away from a mean, etc.) to identify a pricing event that is outside of a reasonable tolerance of the mean value of similar features within that cluster. This may trigger a flag, an alarm, a message, or the like.

Each appraisal form may have associated with it metadata that includes lender guidelines. The lender guidelines may require the population of certain minimal essential fields that must be included as part of the appraisal (as an example, lot size, number of bathrooms, number of bedrooms, number of total rooms, etc.). The form will include, in the metadata, guidelines from the lender that will either prompt the appraiser to include entries for required information or include, at a minimum, an audit note indicating that there was non-compliance with the lender guidelines, or a deviation from the lender guidelines, for the number of features that were omitted in the appraisal report.

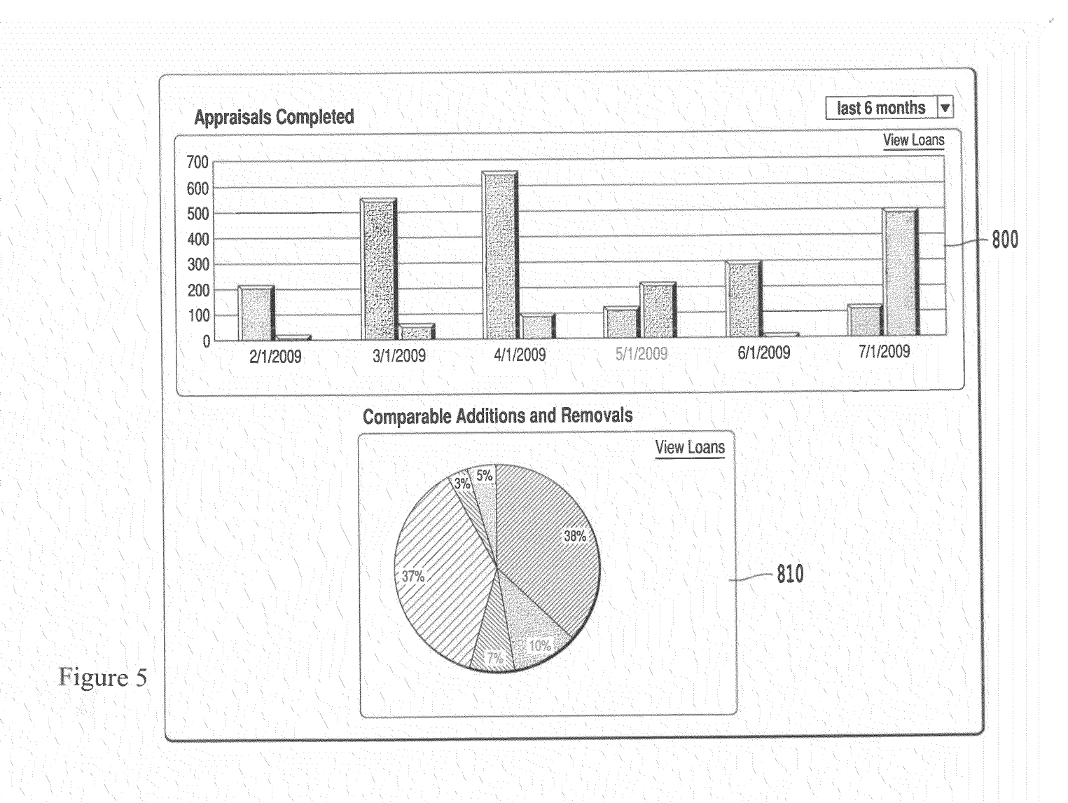

As noted above, various types of analytics may be created using the audit tracking database and/or the processing apparatus 18. FIG. 5 shows an example of analytical data that may be gathered or collected based on various appraisal reports. The analytical report may be comprised of any type of related data or data of interest. For example, analytics may be collected based on each individual appraiser, over an appraisal company or firm, over appraisers in different geographic areas, or the like. Accordingly, the analytics may be as “customizable” as desired, and virtually all types of data may be collected and used in providing the real-time feedback to an appraiser.

The analytics compiled in FIG. 5 include an Appraisals Completed graph 800, and a Comparable Additions and Removals chart 810. The Appraisals Completed graph 800, for example, shows the number of appraisals that have been completed (for example, by an appraiser or an appraisal firm) in the last six months (i.e., from February 2009 to July 2009). This type of data may be used to show an appraiser's productivity, for example, or to check that an appraiser is completing a certain required number of reports during a given period of time (i.e., weekly, bi-weekly, monthly, yearly, or the like). The Comparable Additions and Removals chart 810 may show percentages of properties that were added and/or removed from an appraisal report. This information may be used to show the trends of each appraiser, or the trends of a group of appraisers (i.e., appraisers in a certain geographic area, or appraisers working at a certain firm). For example, the Comparable Additions and Removals chart 810 may show that a certain appraiser has removed over 80% of the comparable properties over a given time. This may raise the interest of the appraiser's reviewer, and more investigations may be performed.

The aforementioned analytics may be used to provide real-time feedback to the appraiser, as noted above. Analytics may be designed, for example, to assess the risk associated with specific appraiser decisions on a current report, including but not limited to comparable sale selection or modification, comparable listing selection or modification, adjustments, text, explanations, and submission attempts. Analytics may further be used to assess macro-level appraiser decisions on multiple reports, including but not limited to the number of appraisals in process or submitted over a specific period of time, geographic coverage, the number of submissions required to achieve an acceptable report, the average time to complete appraisals, or the databases used by the appraiser. In addition, analytics may be used in the assessment of geographic risk for all appraisals in a specific area, including but not limited to corrections of county level data, appraiser indications of market stability, groups of appraisers, including but not limited to appraisers grouped by firm, AMC, credentials, state or some other grouping, or groups of properties, including but not limited to types of properties such as condominiums, properties securing loans made by specific lenders, properties securing loans insured by specific insurers, properties securing loans purchased by specific investors, or other property grouping.

As noted above, analytics may be used to correct county records. For example, county records may indicate that a certain home has 3 bedrooms. Appraisers may note in the comments 760 column of FIG. 4, for example, that the records are incorrect, and that the property actually includes 4 bedrooms, not 3. Such information provided by appraisers may be flagged and sent (either automatically as soon as it is entered or manually after further consideration) to the county records database and/or systems.

Analytics may further be used to show the trend of properties (i.e., how the prices of properties in a certain area have changed) over time, or, for example, the standard deviation of adding a pool to a property in a certain area. As noted above, the analytics data is used to create the real-time feedback presented to an appraiser during the creation of a report. In addition, the analytics may also be used to create certain rules for future appraisal reports. These rules may be embedded in an appraisal form, for example the Fannie Mae 1004 form. The rules may be stored in the real estate database 12, a storage unit of the processing apparatus 18, or in any other database or storage device.

Based on the analytics, for example, in a certain area, a swimming pool may be appraised equivalently to a two-car garage, or an extra bedroom. Accordingly, the system 10 may have a set rule in which a property with a pool may be correctly compared to another property, without a swimming pool, but with an extra bedroom.

Therefore, the computing device 16 transmits its position to a GPS. The GPS locates the property and associates the property with the region the property is in (i.e., 100 to 400 Main Street in Tustin, Calif.). Based on this location, the system 10 searches for any type of rule or analytical data it has associated with that region. In this case, if the above rule regarding the swimming pool applies to the properties located in the range of 100 to 400 Main Street in Tustin, Calif., and the subject property is a 4-bedroom house with a swimming pool, the appraiser may be prompted with the following rule:
“In this area, there are no comparables with a swimming pool. However, since a swimming pool is equivalent to an extra bedroom, you may choose comparables with 5 bedrooms.”
   Therefore, the appraiser may add 5-bedroom homes as comparables. The comments 760 column of FIG. 4, for example, may include a note automatically generated, based on the aforementioned rule, indicating that the comparable was added due to a rule. Additionally, the appraiser may also include any other comments he/she may have.

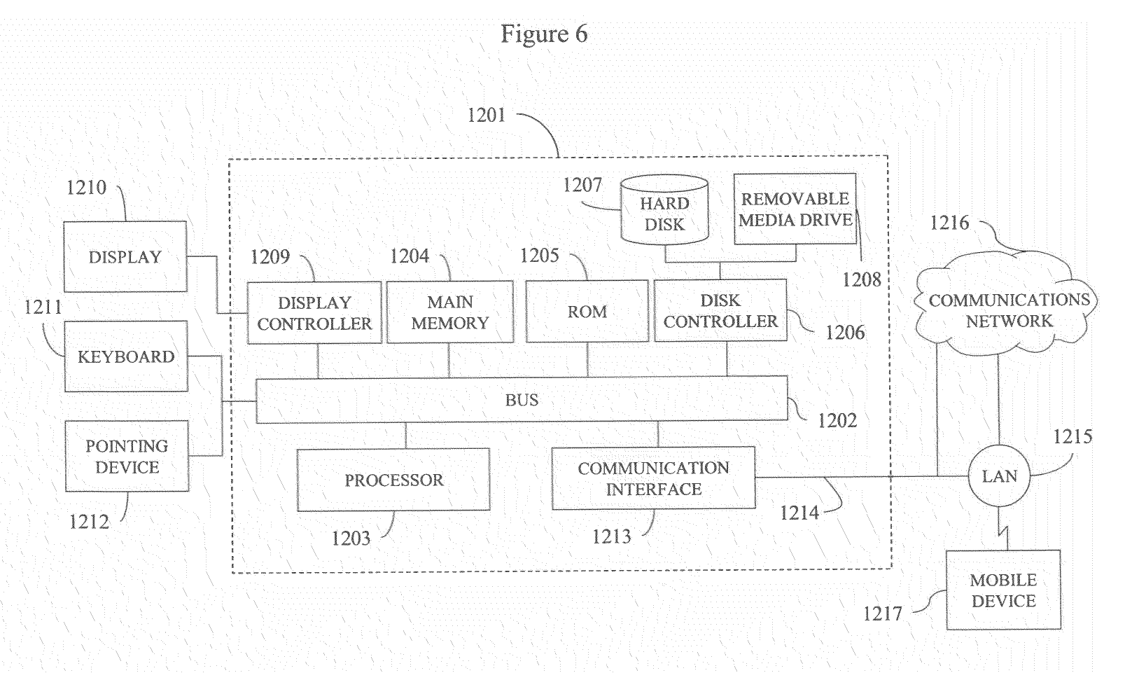

FIG. 6 illustrates a computer system 1201 upon which an embodiment of the electronic appraisal system 10, according to the present embodiments, may be implemented. Furthermore, the processing apparatus 18 and the computing device 16 may be implemented as computer system 1201. The computer system 1201 includes a disk controller 1206 coupled to the bus 1202 to control one or more storage devices for storing information and instructions, such as a magnetic hard disk 1207, and a removable media drive 1208 (e.g., floppy disk drive, read-only compact disc drive, read/write compact disc drive, compact disc jukebox, tape drive, and removable magneto-optical drive). The storage devices may be added to the computer system 1201 using an appropriate device interface (e.g., small computer system interface (SCSI), integrated device electronics (IDE), enhanced-IDE (E-IDE), direct memory access (DMA), or ultra-DMA).

The computer system 1201 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system 1201 may also include a display controller 1209 coupled to the bus 1202 to control a display 1210, such as the touch panel display 101 or a liquid crystal display (LCD), for displaying information to a computer user. The computer system includes input devices, such as a keyboard 1211 and a pointing device 1212, for interacting with a computer user and providing information to the processor 1203. The pointing device 1212, for example, may be a mouse, a trackball, a finger for a touch screen sensor, or a pointing stick for communicating direction information and command selections to the processor 1203 and for controlling cursor movement on the display 1210. In addition, a printer may provide printed listings of data stored and/or generated by the computer system 1201.

The computer system 1201 performs a portion or all of the processing steps of the present disclosure in response to the processor 1203 executing one or more sequences of one or more instructions contained in a memory, such as the main memory 1204. Such instructions may be read into the main memory 1204 from another computer readable medium, such as a hard disk 1207 or a removable media drive 1208. One or more processors in a multi-processing arrangement may also be employed to execute the sequences of instructions contained in main memory 1204. In alternative embodiments, hard-wired circuitry may be used in place of or in combination with software instructions. Thus, embodiments are not limited to any specific combination of hardware circuitry and software.

As stated above, the computer system 1201 includes at least one computer readable medium or memory for holding instructions programmed according to the teachings of the present disclosure and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes.

Stored on any one or on a combination of computer readable media, the present disclosure includes software for controlling the computer system 1201, for driving a device or devices for implementing the invention, and for enabling the computer system 1201 to interact with a human user (e.g., print production personnel). Such software may include, but is not limited to, device drivers, operating systems, development tools, and applications software. Such computer readable media further includes the computer program product of the present disclosure for performing all or a portion (if processing is distributed) of the processing performed in implementing the invention.

The computer code devices of the present embodiments may be any interpretable or executable code mechanism, including but not limited to scripts, interpretable programs, dynamic link libraries (DLLs), Java classes, and complete executable programs. Moreover, parts of the processing of the present embodiments may be distributed for better performance, reliability, and/or cost.

The term “computer readable medium” as used herein refers to any non-transitory medium that participates in providing instructions to the processor 1203 for execution. A computer readable medium may take many forms, including but not limited to, non-volatile media or volatile media. Non-volatile media includes, for example, optical, magnetic disks, and magneto-optical disks, such as the hard disk 1207 or the removable media drive 1208. Volatile media includes dynamic memory, such as the main memory 1204. Transmission media, on the contrary, includes coaxial cables, copper wire and fiber optics, including the wires that make up the bus 1202. Transmission media also may also take the form of acoustic or light waves, such as those generated during radio wave and infrared data communications.

Various forms of computer readable media may be involved in carrying out one or more sequences of one or more instructions to processor 1203 for execution. For example, the instructions may initially be carried on a magnetic disk of a remote computer. The remote computer can load the instructions for implementing all or a portion of the present disclosure remotely into a dynamic memory and send the instructions over a telephone line using a modem. A modem local to the computer system 1201 may receive the data on the telephone line and use an infrared transmitter to convert the data to an infrared signal. An infrared detector coupled to the bus 1202 can receive the data carried in the infrared signal and place the data on the bus 1202. The bus 1202 carries the data to the main memory 1204, from which the processor 1203 retrieves and executes the instructions. The instructions received by the main memory 1204 may optionally be stored on storage device 1207 or 1208 either before or after execution by processor 1203.

The computer system 1201 also includes a communication interface 1213 coupled to the bus 1202. The communication interface 1213 provides a two-way data communication coupling to a network link 1214 that is connected to, for example, a local area network (LAN) 1215, or to another communications network 1216 such as the Internet. For example, the communication interface 1213 may be a network interface card to attach to any packet switched LAN. As another example, the communication interface 1213 may be an asymmetrical digital subscriber line (ADSL) card, an integrated services digital network (ISDN) card or a modem to provide a data communication connection to a corresponding type of communications line. Wireless links may also be implemented. In any such implementation, the communication interface 1213 sends and receives electrical, electromagnetic or optical signals that carry digital data streams representing various types of information.

The network link 1214 typically provides data communication through one or more networks to other data devices. For example, the network link 1214 may provide a connection to another computer through a local network 1215 (e.g., a LAN) or through equipment operated by a service provider, which provides communication services through a communications network 1216. The local network 1214 and the communications network 1216 use, for example, electrical, electromagnetic, or optical signals that carry digital data streams, and the associated physical layer (e.g., CAT 5 cable, coaxial cable, optical fiber, etc.). The signals through the various networks and the signals on the network link 1214 and through the communication interface 1213, which carry the digital data to and from the computer system 1201 may be implemented in baseband signals, or carrier wave based signals. The baseband signals convey the digital data as unmodulated electrical pulses that are descriptive of a stream of digital data bits, where the term “bits” is to be construed broadly to mean symbol, where each symbol conveys at least one or more information bits. The digital data may also be used to modulate a carrier wave, such as with amplitude, phase and/or frequency shift keyed signals that are propagated over a conductive media, or transmitted as electromagnetic waves through a propagation medium. Thus, the digital data may be sent as unmodulated baseband data through a “wired” communication channel and/or sent within a predetermined frequency band, different than baseband, by modulating a carrier wave. The computer system 1201 can transmit and receive data, including program code, through the network(s) 1215 and 1216, the network link 1214 and the communication interface 1213. Moreover, the network link 1214 may provide a connection through a LAN 1215 to a mobile device 1217 such as a personal digital assistant (PDA) laptop computer, or cellular telephone.

Further, it should be appreciated that the exemplary embodiments of the present disclosure are not limited to the exemplary embodiments shown and described above. While this invention has been described in conjunction with exemplary embodiments outlined above, various alternatives, modifications, variations and/or improvements, whether known or that are, or may be, presently unforeseen, may become apparent. Accordingly, the exemplary embodiments of the present disclosure, as set forth above are intended to be illustrative, not limiting. The various changes may be made without departing from the spirit and scope of the invention. Therefore, the disclosure is intended to embrace all now known or later-developed alternatives, modifications, variations and/or improvements.

1. A portable electronic appraisal device comprising:
a display;
a data input module;
a location detection module configured to detect a geographic position;
a communications interface configured to communicate with a real estate database, and retrieve real estate data for a property located at the geographic position detected by the location detection module;
a processor configured to create an electronic appraisal template including a plurality of data fields, the plurality of data fields being automatically populated based on the received real estate data for the property located at the geographic position; and
an audit tracking module configured to maintain a record of data initially presented for inclusion in an appraisal report, but ultimately excluded from the appraisal report.

2. The portable electronic appraisal device according to claim 1, wherein the audit tracking module is further configured to maintain a record of a modification in the appraisal report by including a date and time of modification and an identification of an appraiser making the modification.

3. The portable electronic appraisal device according to claim 2, wherein the audit tracking module is further configured to create an audit trail report, the audit trail report including the record of data initially presented for inclusion in the appraisal report, but ultimately excluded from the appraisal report, and the record of the modification in the appraisal report.

4. The portable electronic appraisal device according to claim 1, further comprising:
an image capturing module configured to capture images of the property located at the geographic position, wherein
the processor is further configured to upload the images to the electronic appraisal template.

5. The portable electronic appraisal device according to claim 1, wherein the real estate data includes data of properties comparable to the property located at the geographic position.

6. An electronic appraisal system comprising:
a real estate database;
a processing apparatus configured to generate an appraisal report; and
a portable electronic appraisal device including
a display,
a data input module,
a location detection module configured to detect a geographic position,
a communications interface configured to communicate with the real estate database, and retrieve real estate data for a property located at the geographic position detected by the location detection module,
a processor configured to create an electronic appraisal template including a plurality of data fields, the plurality of data fields being automatically populated based on the received real estate data for the property located at the geographic position, and
an audit tracking module configured to maintain a record of data initially presented for inclusion in the appraisal report, but ultimately excluded from the appraisal report.

7. The electronic appraisal system according to claim 6, wherein the audit tracking module is further configured to maintain a record of a modification in the appraisal report by including a date and time of modification and an identification of an appraiser making the modification.

8. The electronic appraisal system according to claim 7, wherein the audit tracking module is further configured to create an audit trail report, the audit trail report including the record of data initially presented for inclusion in the appraisal report, but ultimately excluded from the appraisal report, and the record of the modification in the appraisal report.

9. The electronic appraisal system according to claim 6, wherein the portable electronic appraisal device further includes
an image capturing module configured to capture images of the property located at the geographic position, wherein
the processor is further configured to upload the images to the electronic appraisal template.

10. The electronic appraisal system according to claim 6, wherein the processing apparatus creates rules based on analytical data collected from a plurality of previously generated appraisal reports.

11. The electronic appraisal system according to claim 10, wherein the rules correspond to a particular geographic region.

12. The electronic appraisal system according to claim 6, wherein the real estate database includes information corresponding to Multiple Listing Service (MLS) information, Tax Roll information, Automated Valuation Model (AVM) information, and Real Estate Owned (REO) information.

13. The electronic appraisal system according to claim 6, wherein the real estate data includes data of properties comparable to the property located at the geographic position.

14. A method for an electronic appraisal comprising:
detecting a geographic position of a portable electronic appraisal device;
communicating with a real estate database;
retrieving real estate data for a property located at the geographic position detected;
creating an electronic appraisal template including a plurality of data fields, the plurality of data fields being automatically populated based on the received real estate data for the property located at the geographic position; and
maintaining a record of data initially presented for inclusion in an appraisal report, but ultimately excluded from the appraisal report.

15. The method according to claim 14, further comprising:
maintaining a record of a modification in the appraisal report by including a date and time of modification and an identification of an appraiser making the modification.

16. The method according to claim 15, further comprising:
creating an audit trail report, the audit trail report including the record of data initially presented for inclusion in the appraisal report, but ultimately excluded from the appraisal report, and the record of the modification in the appraisal report.

17. The method according to claim 14, further comprising:
capturing images of the property located at the geographic position; and
uploading the images to the electronic appraisal template.

18. The method according to claim 14, further comprising:
collecting analytical data corresponding to a plurality of appraisal reports; and
creating rules based on the analytical data collected from the plurality of appraisal reports, the rules corresponding to a particular geographic region.

19. A computer-readable storage medium including computer executable instructions, wherein the instructions, when executed by a computer, cause the computer to perform a method for an electronic appraisal, the method comprising:
detecting a geographic position of a portable electronic appraisal device;
communicating with a real estate database;
retrieving real estate data for a property located at the geographic position detected;
creating an electronic appraisal template including a plurality of data fields, the plurality of data fields being automatically populated based on the received real estate data for the property located at the geographic position; and
maintaining a record of data initially presented for inclusion in an appraisal report, but ultimately excluded from the appraisal report.

20. An electronic appraisal system comprising:
a real estate database;
an appraisal report module configured to generate an appraisal report;
a display;
a data input module;
a location detection module configured to detect a geographic position;
a communications interface configured to communicate with the real estate database, and retrieve real estate data for a property located at the geographic position detected by the location detection module;
a processor configured to create an electronic appraisal template including a plurality of data fields, the plurality of data fields being automatically populated based on the received real estate data for the property located at the geographic position; and
an audit tracking module configured to maintain a record of data initially presented for inclusion in the appraisal report, but ultimately excluded from the appraisal report.
